(19) United States
(12) Patent Application Publication
(10) Pub. No.: US 2007/0165948 A1
(43) Pub. Date: Jul. 19, 2007

(54) Mesh models with internal discrete elements

(75) Inventors: Franck Laffargue, Poissy (FR); Maxim Fradkin, France (FR); Jean-Michel Rouet, Paris (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,085

(22) PCT Filed: Jan. 5, 2005
(86) PCT No.: PCT/IB05/00051

§ 371 Date: Jul. 11, 2006

(30) Foreign Application Priority Data
Jan. 13, 2004 (EP) 04300019.9

(51) Int. Cl. G06K 9/34; G06K 9/36

(52) U.S. Cl. 382/173; 382/276

(57) ABSTRACT

An image processing system having image data processing means of segmentation of an object of interest using an unstructured deformable mesh model composed of surface (T_{J}) and internal (TH_{J}) discrete elements, and further means of refining said mesh model by automatically dynamically adapting the size of the internal discrete elements to the local variation of size of the surface discrete elements. This system has means for acquiring size information (L_{J}) related to the surface discrete elements in order to evaluate the optimal size to be assigned to the internal discrete elements and for propagating this size information from the surface discrete elements to the internal discrete elements while new internal discrete (TH_{J}) elements are created during the refinement process by insertion of new vertices inside said internal discrete elements.

### FIELD OF THE INVENTION

The invention relates to an image processing system having image data processing means for the segmentation of an object of interest in a two-dimensional or in a three-dimensional image, comprising an operation of mapping a deformable mesh model onto said object of interest. The invention further relates to a medical examination apparatus for producing medical two-dimensional or three-dimensional images to be processed by the processing system, for the segmentation of objects such as body organs, or body fluid flow, in order to study or detect abnormalities or pathologies. The invention finds a particular application in the field of medical imaging methods, program products and apparatus or systems.

### BACKGROUND OF THE INVENTION

In three-dimensions, tetrahedral meshes, i.e. volumetric meshes composed of tetrahedrons, are mainly used for modeling a physical quantity in three-dimensional objects such as blood flow in vascular system. The adaptation of the shape of the mesh elements is essential because it highly influences the precision and stability of the computation. The ideal element shape is a regular tetrahedron having equilateral faces and same edge length.

The tetrahedral meshes are created from surface meshes composed of triangles. The triangle mesh is a description of the surface of the 3D object, while the tetrahedral mesh is a description of the volume within the same 3D object. Both types of meshes share the same surface triangulation.

The generation of tetrahedral meshes is mainly based on the so-called Delaunay Tetrahedrization method. The Delaunay method is for instance disclosed in the publication entitled “Reasonably efficient Delaunay based mesh generator in three dimensions” by H. Borouchaki, F. Hecht, E. Saltel and P. L. George, dated Aug. 23, 1995 (INRIA, Domaine de Rocquencourt, BP 105, 78153 Le Chesnay Cedex FRANCE, EUROPE).

According to this method, tetrahedral elements are created by incrementally inserting new vertices according to the Delaunay criterion, inside tetrahedrons that have to be refined. The method starts with a mesh surface, whose mesh is composed of triangles, and further generates a rough volumetric mesh, with tetrahedrons having common vertices with the vertices of the surface meshes. Then, this volumetric mesh is incrementally refined using the Delaunay approach until an optimal element size is obtained.

The issue is how to define elements actually showing optimal shapes and sizes. A quick and simplistic solution is to give the same size to each tetrahedral elements of the volumetric mesh. However, this approach is very limited, because it does not take into account local size variation of the surface triangular meshes, which can lead to ill-shaped volumetric elements.

### SUMMARY OF THE INVENTION

The object of the invention is to provide an image processing system comprising image data processing means to carry out a fully automatic method, which is able to generate either a volumetric mesh model in a 3D image or an internal mesh model in a 2D image. This volumetric mesh model is composed of tetrahedral elements that are created from surface meshes composed of triangles, and which automatically dynamically adapts the tetrahedral element size according to the local variation of size of the surface triangles. The internal mesh model is composed of triangular elements created from contour meshes composed of segments, and which automatically adapts the triangular elements to local variation of size of the contour segments. The volumetric tetrahedral element and the internal triangle elements are further called discrete internal elements, while the surface triangle elements and the contour segment elements are called discrete surface elements.

The object of the invention is to propose an image processing system comprising image data processing means to estimate mesh quality of the discrete internal elements. According to the invention, the mesh model is refined by insertion of new vertices inside said discrete internal elements. The system of the invention comprises processing means for refinement of the process including:
means for acquiring size information defined by the discrete surface elements in order to evaluate the optimal size to be assigned to the discrete internal elements; and
means for propagating this size information from the discrete surface elements to the discrete internal elements while new discrete internal elements are created during the refinement process.

It is also an object of the present invention to propose an image processing method with steps for operating this system. The invention also relates to a medical diagnostic imaging apparatus coupled to this system for 3-D image processing. The medical imaging apparatus may be a MRI medical examination apparatus or an X-ray medical examination apparatus or any other 3-D medical imaging apparatus. The invention further relates to a program product or a program package for carrying out the image processing method.

### BRIEF DESCRIPTION OF THE DRAWINGS

The invention is described hereafter in detail in reference to the following diagrammatic and schematic drawings, wherein:

FIG. 1A and FIG. 1B shows diagrammatic representations of the means of the system of the invention for modeling an object respectively with a volumetric mesh model and with a surface mesh model;

FIG. 2A, FIG. 2B, FIG. 2C and FIG. 2D illustrate different possibilities of vertex insertion for refining tetrahedrons in a volumetric deformable mesh model, among which FIG. 2A illustrates the option of inserting a vertex at the middle of an edge; FIG. 2B illustrates the option of inserting a vertex at the center point of a of a triangular face of the tetrahedron; FIG. 2C illustrates the option of inserting a vertex at the center point of the tetrahedron; FIG. 2C illustrates the option of inserting a vertex at the center point of the circum-sphere of the tetrahedron;

FIG. 3A, FIG. 3B and FIG. 3C illustrate the application of Delaunay's criterion for refining meshes, among which FIG. 3A illustrates the determination of the weight of a vertex; FIG. 3B and FIG. 3C illustrate the insertion of a vertex in a triangle;

FIG. 4A represents a segmented contour of a 2D object; FIG. 4B represents 2D discrete internal elements constructed from the contour and FIG. 4C represents refined 2D discrete internal elements;

FIG. 5A shows a segmented surface of a 3D object where the surface mesh is formed of a set of triangles; FIG. 5B shows the volumetric mesh model constructed with rough tetrahedrons, whose vertices are those of this surface mesh model; FIG. 5C shows this volumetric mesh model, whose tetrahedrons are refined according to the invention, and formed of smaller tetrahedrons adapted to the triangles of the surface;

FIG. 6A shows a segmented surface where the surface mesh is formed of another set of triangles; FIG. 6B shows a segmented volume where the volumetric mesh is refined according to the invention, and formed of smaller tetrahedrons that are adapted to these other triangles of the surface;

FIG. 7 illustrates a medical viewing system coupled to a medical examination apparatus.

### DETAILED DESCRIPTION OF EMBODIMENTS

The invention relates to the improvement of medical images representing an object of interest to be studied. The object of interest may be a blood vessel, such as the Abdominal Aorta, for studying Abdominal Aortic Aneurisms (AAA), represented in two-dimensional or in three-dimensional medical images.

These images may be used for the study and detection of cardiovascular diseases by means of a patient-specific computation fluid dynamic (CFD) simulation of the blood flow and the short- and long-term reaction of the vascular system to this flow. In this context, the CFD simulations consist in modeling by finite-element method (FEM) the geometrical and the mechanical information about the vessel components. The geometrical information will come from the segmentation of the medical image in the form of three-dimensional surface meshes (voxel classification). For the FEM, a mandatory step is the tessellation of surface meshes into volume meshes composed of finite volume elements. This operation is called volume mesh generation.

In three dimensions, the finite volume elements are usually of two possible types, called tetrahedral and hexahedral types, each of them being represented as a set of points and connections between these points.

In the case when the finite volume elements are of the hexahedral type, a type of volume mesh model, called structured mesh, is associated to the element type. A structured mesh consists of a set of points and regular connections (i.e constant adjacency number, for example always three adjacent elements, no more, no less) at each point.

The present invention does not relate to the possible shape known as hexahedral shape. Instead, according to the invention, the finite volume elements are of the tetrahedral type. In the case of the tetrahedral type, a type of volume mesh model, called unstructured mesh, is associated to the element type. The connections of each point are not regular (for example the number may vary; three or four or five or more adjacent elements may be found).

An advantage of unstructured meshes is their flexibility that allows tetrahedral elements to fit irregular boundaries with a good accuracy. Another advantage of unstructured meshes is that they can be automatically generated. Another advantage of unstructured meshes is their ability to satisfy mesh adaptation requirement. Indeed, it is often required that the mesh be controllable in order to allow a trade-off between accuracy and calculation time. In this case, the element density must vary depending on local accuracy requirements and this variation must be smooth. This is called mesh adaptation. With unstructured elements, the variation of element size and density can be controlled because the connectivity is not constrained. For tetrahedral elements, the best precision in calculation is obtained with regular tetrahedrons. In order to guaranty a sufficient accuracy, the mesh must satisfy an optimum, for instance minimum, of a quality criterion that measures the geometric shape quality of its elements.

The present invention relates to a first embodiment of an image processing system for automatically segmenting an object of interest represented in a three-dimensional image, using a three-dimensional discrete Deformable Volumetric Mesh Model. The Surface S of the Volumetric Mesh Model of segmentation is fitted onto the surface of said three-dimensional object and the volumetric meshes V of the Model are adapted to the meshes of the surface S. According to the invention, tetrahedral meshes, i.e. volumetric meshes composed of tetrahedrons, are created from surface meshes composed of triangles. The triangle mesh is a description of the surface of the 3D object of interest, while the tetrahedral mesh is a description of the volume within the same 3D object. Both types of meshes share the same surface triangulation. The ideal element shape is the regular tetrahedron with equilateral faces and same edge length.

The present invention further relates to another embodiment of the image processing system for segmenting an object of interest represented in a two-dimensional image, using a two-dimensional discrete Deformable Mesh Model. This system comprises means whereby segments of an Outline S of the Deformable 2D Mesh Model of segmentation are fitted onto the boundary of said object in the 2D image, and triangular meshes V internal to the Outline are adapted to the size of the segments of the Outline. The object of interest may be a cross-section of an organ represented in a two-dimensional medical image.

According to the invention, the triangular meshes, i.e. internal meshes V of the Outline S, are created from the Outline composed of segments. The segmented Outline mesh is a description of the surface of the 2D object of interest represented in a 2D image, while the 2D area composed of triangular meshes is a description of the region within the Outline of the same 2D object. The ideal internal element shape is the equilateral triangle.

In fact, the invention has means to solve the same problem in tree-dimensional images or in two-dimensional images. The present invention proposes an image processing system having image data segmentation means for automatic optimisation of the size of discrete internal elements with respect to the segmented contour of surface of an object. These discrete internal elements are either 3D tetrahedrons with respect to a 3D segmentation surface formed of triangles, or 2D equilateral triangles with respect to a 2D segmentation contour formed of segments.

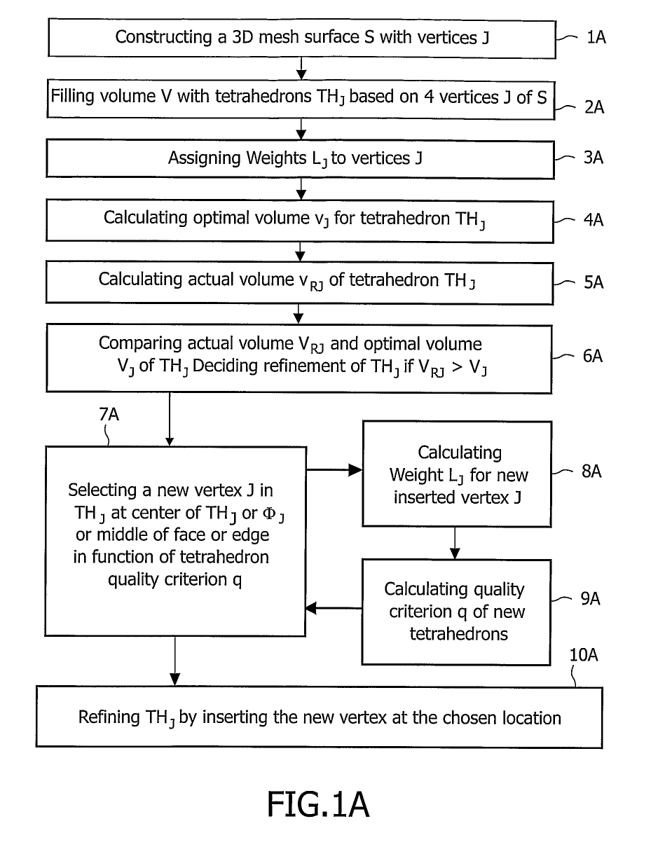

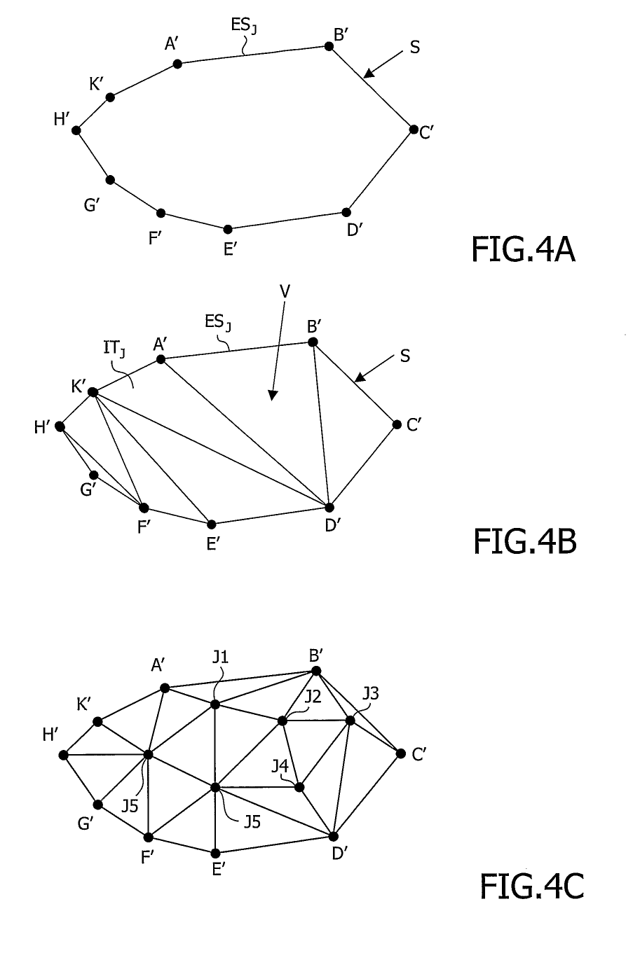

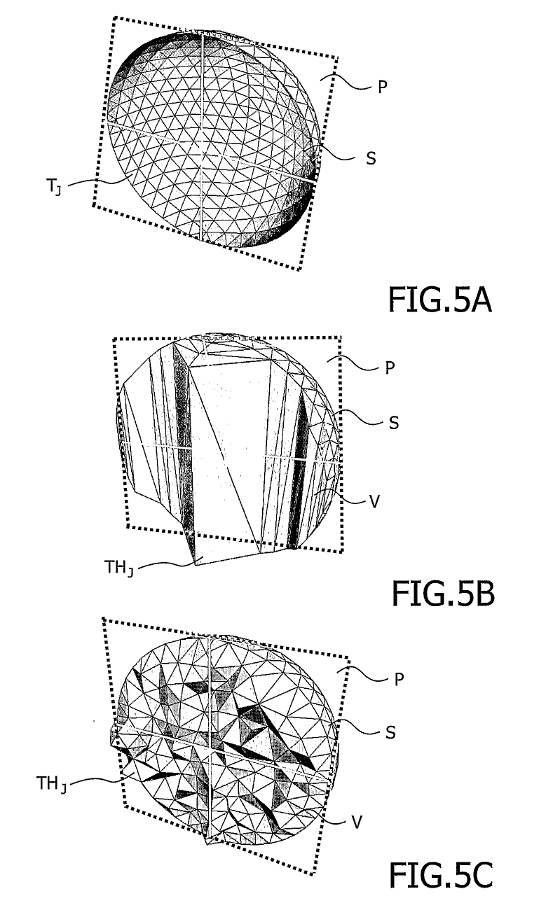

A first embodiment is described for modeling a 3D object using a volumetric mesh model. FIG. 1A is a diagrammatic representation of the means of the system of the invention relating to this first embodiment. Images processed according to the invention are shown in FIG. 5A to FIG. 5C and FIG. 6A, FIG. 6B. FIG. 5A represents a surface mesh S of a sphere composed of triangles and FIG. 5B represents an initial volumetric mesh V of the same sphere, both images being clipped to a plane P in order to see inside the sphere. The segmentation surface S formed of triangles is first made available. From said surface mesh S of the 3D object, an initial tetrahedral mesh V of the same object is created. All the vertices of the tetrahedrons of the initial volumetric mesh V are vertices of triangles of the surface S. Thus, the tetrahedral elements are all connected to the surface of the object. As illustrated by FIG. 5B, this volumetric mesh has very flat tetrahedral elements, which results in poor shape quality of the tetrahedrons, and presents a large variation in tetrahedron sizes and volumes.

Referring to FIG. 1A, the automatic system of the invention first comprises data processing means for automatically and dynamically constructing an unstructured volumetric mesh model, including:

1) Computing means 1A for creating the discrete surface elements of the 3D segmentation surface S, which are formed of triangles T_{J} defined by their vertices on S, adjacent by their edges, as illustrated by FIG. 5A;

2) Computing means 2A for creating the initial volumetric elements V, which are tetrahedrons denoted by TH_{J}, whose four vertices are vertices of S: this ensues that such tetrahedrons may be very flat, as illustrated by FIG. 5B, which is the reason why they are called rough.

The automatic system also comprises computing means for refining the initial volumetric elements, including:
estimation means 3A for acquiring size information of the surface elements;
estimation means 4A, 5A to evaluate the optimal size to be assigned to the volumetric elements TH_{J} of V, using the size information related to the surface elements T_{J} of S; and
refinement means 6A to 10A for propagating this size information from the surface S to the volume V while new volumetric elements TH_{J} are created during the refinement process.

According to the invention, the volumetric elements are refined by insertion of new vertices inside the initial volumetric elements, taking the size information of the surface elements into account. Referring to FIG. 1A, these refining processing means may favourably comprise in detail:

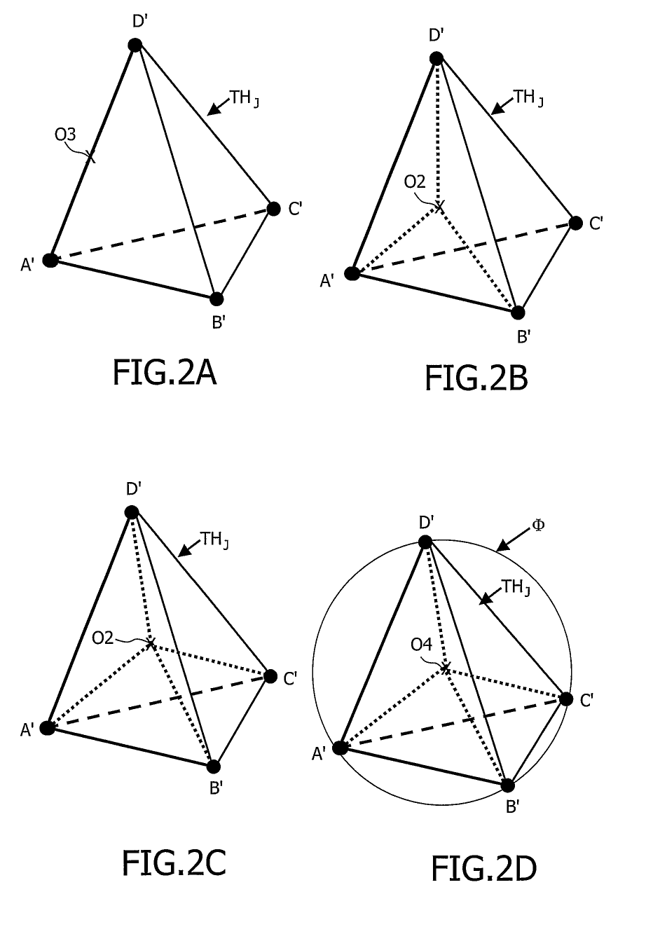

3) Processing means 3A for defining a weight parameter L_{J} assigned to each vertex of the discrete elements: Referring to FIG. 3A, which represents a set of discrete elements, for each vertex of the set, for example for the vertex B, the different lengths of the edges joining said vertex to its neighbor vertices is calculated, for example the lengths of segments BA, BK, BG, BF, BE, BC, BD, and denoted by distances L_{J}. Then, the weight parameter, called optimal distance L_{J}, is calculated for B, and further for the other vertices J of the set of discrete elements. The weight parameter is favorably the average value of the different distances L_{J} related to B, and then to said other vertices J. This operation of calculating the weight parameter L_{J} to be assigned to a vertex J is applied in 3D to the vertices of the initial volumetric elements represented by the rough tetrahedrons TH_{J} of FIG. 5B forming V, said vertices all being on the surface S of segmentation formed of triangles T_{J}.

4) Processing means 4A for calculating an optimal volume vⱼ associated to each tetrahedral element TH_{J}. The initial tetrahedral elements in 3D are based on the vertices of the respective 3D surface mesh. In 3D, the tetrahedral elements, TH_{J}, are based on four vertices of the 3D surface S, each vertex being assigned the respective weight parameter formed by the optimal distance L_{J} previously calculated. Assigning said distance L_{J} to the vertices of the mesh V is possible since the surface mesh S and the volume mesh V share the same surface triangulation. The optimal element shape being the regular tetrahedron, the optimal volume vⱼ is the volume of a regular tetrahedron with edge lengths equal to the average of the 4 optimal distances L_{J} of the vertices composing the element. The volume vⱼ may be given by the following formula (1a):

$${v}_{j} = \frac{{( \frac{1}{4} {\sum }_{i = 1}^{4} {L}_{i} )}^{3}}{6} \qquad ( 1 a )$$

5) Processing means 5A for calculating the real volume v_{RJ} of each initial tetrahedral element.

6) Processing means 6A for comparing the real volume v_{RJ} and the optimal volume v_{J}; and accordingly, to initiate a refinement of the tetrahedron TH_{J} under study:
a) if the real volume v_{RJ} of a tetrahedron TH_{J} is bigger than its optimal volume V_{J}, according to the invention=operating refinement of the tetrahedral element under study, using further processing means 7A; otherwise:
b) skipping to an other tetrahedron of the volume V; and
c) if or when there are no more tetrahedrons to refine, stop refining;

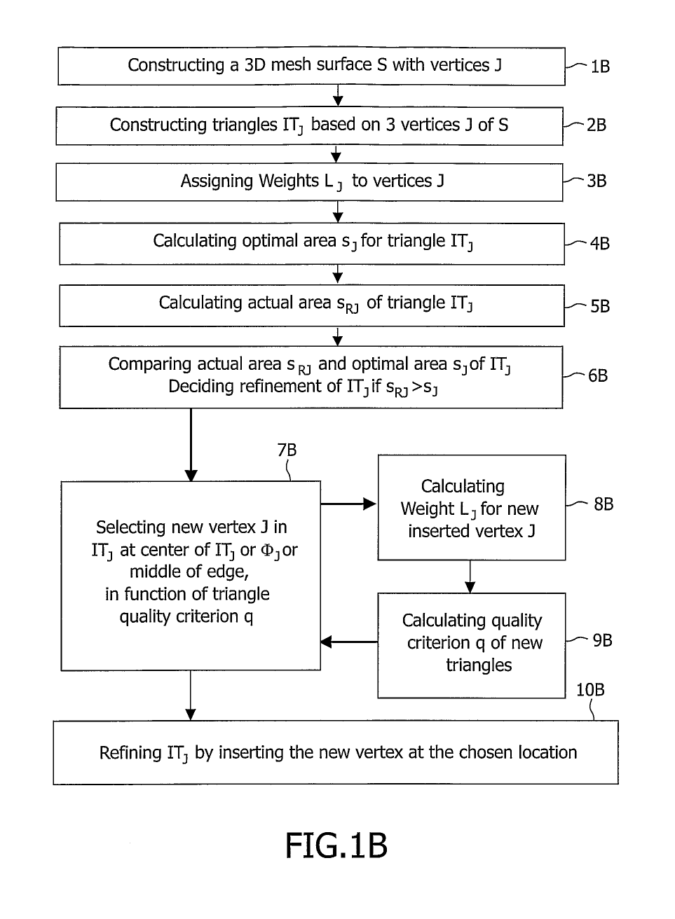

7) Processing means 7A for selecting several location of vertex insertion in a tetrahedron whose real volume v_{RJ} is bigger than the optimal volume v_{J}. For inserting a new vertex, some possible locations are:
at the middle of one of its edges as illustrated by FIG. 2A;
at the middle of one of its faces as illustrated by FIG. 2B;
at the center of the tetrahedron as illustrated by FIG. 2C; or
at the center of the circum-sphere as illustrated by FIG. 2D.

8) Processing means 8A for calculating the parameter called optimal distance L_{J} to be assigned to the newly inserted vertex depending on the chosen location. If the chosen location is:
at the middle of one of its edges (FIG. 2A): the optimal distance to assign to the new inserted vertex is the average of the 2 optimal distances previously calculated and assigned to the 2 vertices at the extremities of the edge;
at the middle of one of its faces (FIG. 2B): the optimal distance to assign to the new inserted vertex is the average of the 3 optimal distances previously calculated and assigned to the 3 vertices of the face;
at the center of the tetrahedron (FIG. 2C): the optimal distance to assign to the new inserted vertex is the average of the 4 optimal distances previously calculated and assigned to the 4 vertices of the tetrahedron;

at the center of the circum-sphere (FIG. 2D): the optimal distance is the average of the 4 optimal distances of the 4 vertices of the tetrahedron.

9) Measure means 9A for calculating a tetrahedron shape quality measure q, based on the shape of each tetrahedron in order to evaluate and compare the shapes provided by each option of inserting vertex. In order to estimate the differences between the four possibilities of inserting a vertex in a tetrahedron as presented above, a first possible criterion is given by the following formula:

$${q}_{J} = \frac{ρ}{h} \qquad ( 2 a )$$

where ρ is the diameter of the inscribed sphere of the tetrahedral element and h is the length of the largest edge of the tetrahedral element.

Another simple criterion for the shape quality q may be:

$${q}_{J} = \frac{ρ}{d} \qquad ( 3 a )$$

where ρ is the diameter of the sphere that is inscribed into the tetrahedron and d is the diameter of the circum-sphere. The location of insertion that will give the best quality of the worst element created is kept.

10) Processing means 10A for refining the mesh by insertion of the new vertex at chosen location. Refining tetrahedrons permits of propagating the optimal size information inside the volume and creates several smaller tetrahedrons for replacing an initial tetrahedron. While creating tetrahedrons, also Delaunay validity criterion is applied.

The Delaunay validity criterion is explained hereafter: A tetrahedron is so-called “Delaunay valid” if and only if its circum-sphere, i.e. the sphere defined by the 4 points of the tetrahedron, encloses no other point of the mesh. By extension, the mesh is Delaunay valid if and only if every mesh elements are Delaunay valid. This criterion is illustrated by FIGS. 3B and 3C, in relation to a 2D image: A new vertex O is inserted in a triangle ACD. However, this new vertex is inside the circum-circle Φ1 of triangle ABC and the circum-circle Φ3 of triangle CDE. Hence, segments AC and CD must be suppressed and new segments OA, OB, OC, OD, OE are created. This permits of creating new triangles AOB, BOC, COE, DOE, AOD.

FIG. 3B and FIG. 3C show how a new point is inserted in a 2D triangular mesh, the process extends in 3D in the same way. Each newly inserted vertex needs to be connected to the mesh. To connect the point, one first locates every tetrahedron for which the circum-sphere overlaps the point, i.e. not Delaunay valid anymore and remove them from the mesh. This defines the enclosing convex cavity, as illustrated in 2D by FIG. 3C. Then, a new construction of tetrahedron is performed by connecting point to the cavity faces.

Hence, using the processing means of the invention, a fully automatic method is applied, which dynamically adapts the tetrahedral element size according to the local variation of size of the surface triangles.

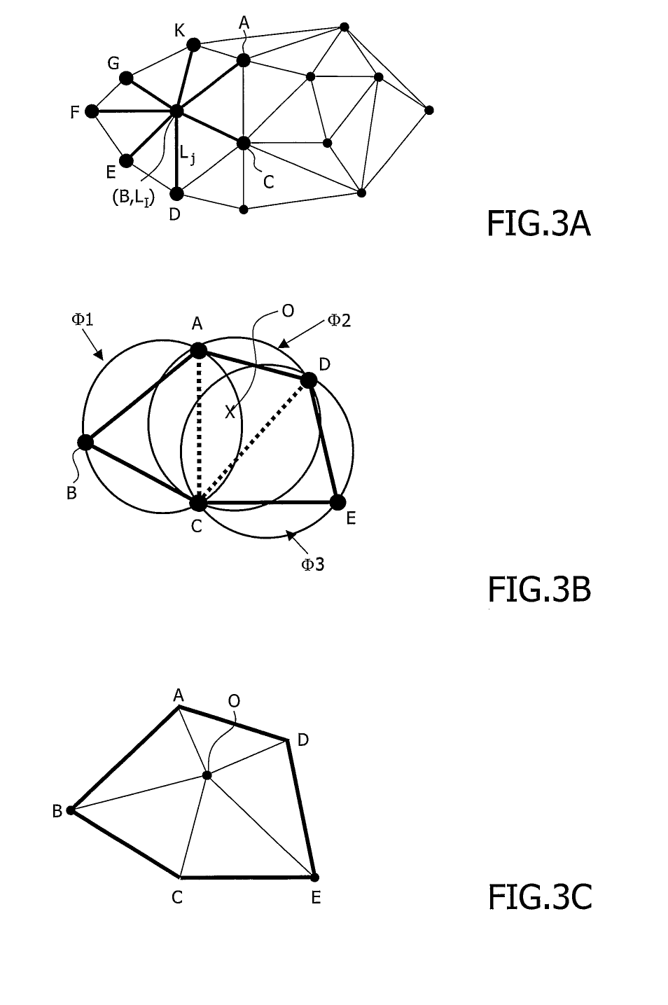

The means of the invention are fully appropriate to be applied to 2D images. A second embodiment is described for segmenting a 2D object using a 2D deformable mesh model. FIG. 1B is a diagrammatic representation of the means of the system of the invention relating to this second embodiment. The 2D segmentation is illustrated by FIG. 4A to FIG. 4C. As illustrated by FIG. 4A, an object of interest is segmented according to a contour mesh S formed of segments ES_{J}. From said contour mesh S of the 2D object, an initial internal 2D mesh V of the same object is created with triangles denoted by IT_{J}. All the vertices of the triangles of the initial internal 2D mesh V are the vertices of segments of the contour S. Besides, this initial internal set of triangles V contains no other vertices than the vertices of the contour mesh S. Thus, the triangles IT_{J} are all connected to the contour of the object. As illustrated by FIG. 4B, the result is quite rough. Since all vertices of V are also vertices of S, this internal mesh has triangular elements whose shape is very far from the equilateral shape, which results in poor shape quality of the mesh.

Referring to FIG. 1B, the automatic and dynamic system of the invention first comprises data processing means for automatically constructing a 2D contour mesh S and internal discrete elements V. these means are comparable to the means of FIG. 1A, including:

1) Computing means 1B for creating the 2D discrete contour elements S, which are formed of segments ES_{J} defined by their vertices A′, B′, C′, . . . , K′ on S, adjacent by their edges, as illustrated by FIG. 4A;

2) Computing means 2B for creating the initial internal discrete elements V, which are triangles IT_{J}, whose three vertices are vertices of S, such as A′B′D′, as illustrated by FIG. 4B;

Computing means 3B to 11B for refining the initial internal elements, including:
estimation means 3B for acquiring size information of the contour elements;
computation means 4B, 5B, using the size information defined by the contour elements of S to evaluate the optimal size to be assigned to the discrete internal elements of V; and
refinement means 6B to 11B for propagating this size information from the contour S to the internal region V while new internal elements are created during the refinement process.

According to the invention, the internal elements are refined by insertion of new vertices inside the initial triangular elements, taking the size information of the contour elements into account. As illustrated by FIG. 1B, these refining processing means may favourably comprise in detail:

3) processing means 3B for defining a weight parameter L_{J} assigned to each vertex of the segmented contour S.

4) Processing means 4B for calculating an associated optimal surface sⱼ associated to each triangular element IT_{J}. In 2D, the triangular elements, denoted by IT_{J}, are based on three vertices of the 2D contour S, each vertex being assigned the respective weight parameter formed by the optimal distance L_{J} previously calculated. The optimal element shape being the regular triangle, the optimal surface sⱼ is the surface of a regular triangle with edge lengths equal to the average of the 3 optimal distances L_{J} of the vertices composing the element.

5) processing means 5B for calculating the real area s_{RJ} of each initial triangular element;

6) processing means 6B for comparing the real area s_{RJ} and the optimal area s_{J}; and accordingly, to initiate a refinement of the triangle IT_{J} under study:
a) if the real area s_{RJ} of a triangle IT_{J} is bigger than its optimal surface S_{J}, according to the invention=operating refinement of the triangle element under study, using further processing means 7B; otherwise:
b) skipping to an other triangle of the internal region V; and
c) if or when there are no more triangles to refine, stop refining;

7) processing means 7B for selecting several location of vertex insertion in the triangle whose real area s_{RJ} is bigger than the optimal area s_{J}. For inserting a new vertex, some possible locations are: at the middle of one of its edges, at the centre of the triangle or at the centre of the circum-circle.

8) processing means 8B for calculating the parameter called optimal distance L_{J} to be assigned to the newly inserted vertex depending of the chosen location. If the chosen location is:
at the middle of one of its edges: the optimal distance to assign to the new inserted vertex is the average of the 2 optimal distances previously calculated and assigned to the 2 vertices at the extremities of the edge;
at the middle of the triangle: the optimal distance to assign to the new inserted vertex is the average of the 3 optimal distances previously calculated and assigned to the 3 vertices of the triangle;
at the center of the circum-circle.

9) Measure means 9B for calculating a triangle shape quality measure q in order to evaluate and compare the shapes provided by each option of inserting vertex.

10) Processing means 10B for refining the mesh by insertion of the new vertex at chosen location.

Hence, using the processing means of the invention, a fully automatic method is applied, which dynamically adapts the triangular element size according to the local variation of size of the contour segments.

Medical Examination Apparatus and Viewing System

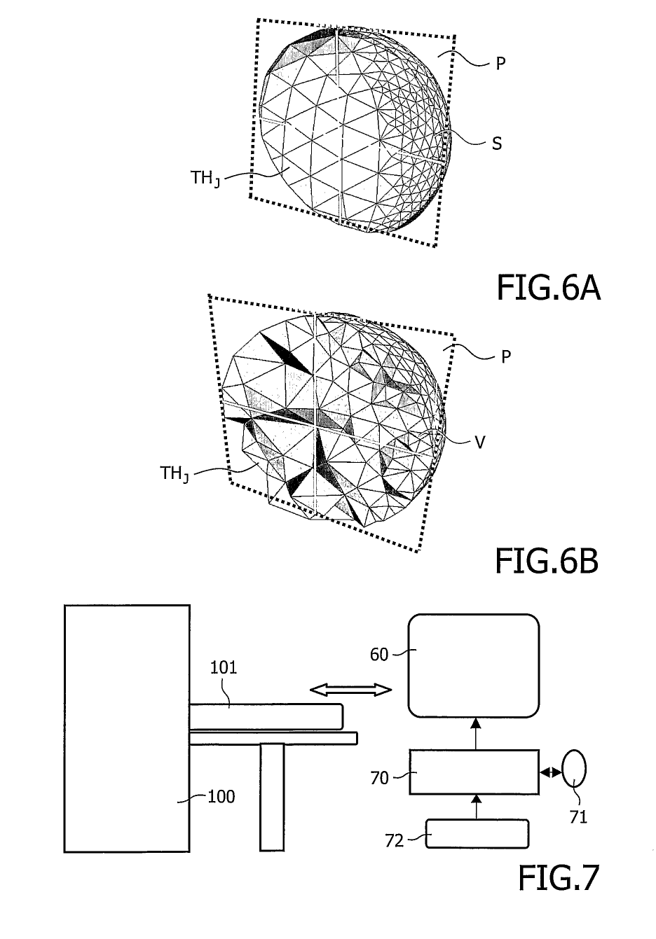

The above-described means are included in or coupled to the viewing system of the invention. FIG. 7 shows the basic components of an embodiment of an image viewing system in accordance to the present invention, incorporated in a medical examination apparatus. The medical examination apparatus 100 may include a bed 110 on which the patient lies or another element for localizing the patient relative to the imaging apparatus. The medical imaging apparatus 100 may be a CT scanner or other medical imaging apparatus such as x-rays or ultrasound apparatus. The image data produced by the apparatus 100 is fed to data processing means 70, such as a general-purpose computer, that comprises computation means and user control means appropriate to form the interactive adaptation means of the invention. The data processing means 70 is typically associated with a visualization device, such as a monitor 60, and an input device 72, such as a keyboard, or a mouse 71, pointing device, etc. operative by the user so that he can interact with the system. The data processing device 70 is programmed to implement the processing means for processing medical image data according to invention. In particular, the data processing device 70 has computing means and memory means necessary to perform the operations described in relation to FIG. 1 and FIG. 4. A computer program product having pre-programmed instructions to carry out these operations can also be implemented.

The drawings and their description herein before illustrate rather than limit the invention. It will be evident that there are numerous alternatives that fall within the scope of the appended claims. Moreover, although the present invention has been described in terms of generating image data for display, the present invention is intended to cover substantially any form of visualization of the image data including, but not limited to, display on a display device, and printing. Any reference sign in a claim should not be construed as limiting the claim.

1. An image processing system having image data processing means of segmentation of an object of interest using an unstructured deformable mesh model composed of surface discrete elements and internal discrete elements, and further comprising means of refining the unstructured deformable mesh model by automatically dynamically adapting the size of the internal discrete elements according to the local variation of size of the surface discrete elements.

2. The image processing system of claim 1, further comprising image data processing means for acquiring size information related to the surface discrete elements in order to evaluate the optimal size to be assigned to the internal discrete elements, and for propagating this size information from the surface discrete elements to the internal discrete elements while new internal discrete elements are created during the refinement process.

3. The image processing system of claim 2, wherein new internal discrete elements are created during the refinement process by insertion of new vertices inside said internal discrete elements.

4. The image processing system of claim 3, comprising image data processing means to estimate mesh quality of the internal discrete elements and to refine the unstructured mesh model based on said estimated mesh quality.

5. The image processing system of claim 4, wherein the unstructured mesh model is a 3D mesh model with surface discrete elements composed of triangles (T_{J}), and internal discrete elements composed of tetrahedrons (TH_{J}); or the unstructured mesh model is a 2D mesh model with surface discrete elements composed of contour segments, and internal discrete elements composed of triangles (IT_{J}).

6. The image processing system of claim 5, wherein, in 3D, the internal tetrahedrons (TH_{J}) are initially constructed based on the vertices of the surface triangles and then refined by inserting vertices either at the middle of a tetrahedron edge; at the middle of a tetrahedron face; at the center of a tetrahedron; or at the center of the circum-sphere of a tetrahedron;
or wherein, in 2D, the internal triangles (IT_{J}) are initially constructed based on the vertices of the contour segments and then refined by inserting vertices either at the middle of a triangle edge; at the middle of a triangle face; or at the center of a triangle.

7. The image processing system of claim 5, comprising:
image data processing means to estimate a weight parameter (L_{J}) assigned to each vertex of the discrete elements based on the average of the lengths of the edges joining said vertex to its neighbor vertices; an optimal volume or surface associated to each internal discrete element, the optimal internal discrete element shape being a regular tetrahedron or triangle and the real volume or surface of each initial internal discrete element; and image data processing means for comparing the real volume or surface with respectively the optimal volume or surface and accordingly to initiate a refinement of an internal discrete element under study if the real volume or surface of the internal discrete element is bigger than its optimal volume or surface.

8. The image processing system of claim 7, comprising image data processing means to estimate a validity criterion according to which a new internal element is valid if and only if its circum-sphere or circum-circle encloses no other vertex of the mesh.

9. The image processing system of claim 7, wherein the image data processing means to estimate mesh quality of the internal discrete elements comprises a criterion based on the length of edges of the internal discrete elements and the diameter of its circum-sphere or circum-circle, and a criterion based on the volume or surface of the internal discrete elements.

10. The image processing system of claim 1, further comprising visualizing means (60) for displaying processed images.

11. The image processing system of claim 1, further comprising means for stopping the refinement of internal discrete elements when a predetermined threshold of mesh quality is met.

12. A medical imaging system comprising a suitably programmed computer or a special purpose processor having circuit means, which are arranged to form an image processing system as claimed in claim 1 to process medical image data;

13. A medical examination imaging apparatus having:
Means to acquire a three-dimensional image of an organ of a body; and
a system according to claim 1.

15. A computer program product comprising a set of instructions to be used in a system as claimed in claim 1.
